(19) United States
(12) Patent Application Publication
(10) Pub. No.: US 2010/0063976 A1
(43) Pub. Date: Mar. 11, 2010

(54) METHOD FOR ACCESSING DATA CONCERNING AT LEAST ONE USER ENABLING SAID USER TO BE CONTACTED SUBSEQUENTLY

(75) Inventors: Emmanuel Bertin, Escoville (FR); Luigi Lancieri, Evrecy (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: France Telecom, Paris (FR)

(21) Appl. No.: 12/067,515

(22) PCT Filed: Sep. 19, 2006
(86) PCT No.: PCT/EP2006/009103

§ 371 Date: Sep. 15, 2008

(30) Foreign Application Priority Data
Sep. 20, 2005 (FR) 05/09607

(51) Int. Cl. G06F 15/173; G06F 17/30

(52) U.S. Cl. 707/769; 709/224; 707/E17.014

(57) ABSTRACT

A method is provided for accessing, via a communication network, data stored in a storage module and concerning at least one user, in particular an identifier enabling the user to be contacted subsequently. The method includes: a) transmitting elements characterizing a user of at least one probe terminal and determined based on traces of communications of the probe terminal with at least one server of the network; b) determining, based on the characterizing elements, a determined profile characteristic pertaining to the user; c) storing the determined profile characteristic in the storing module; d) creating a list of users including, associated with each of the users, at least one identifier for which the profile characteristic stored at step c) corresponds to at least one profile characteristic defined in a request transmitted by a requesting user terminal; and e) transmitting to the requesting user terminal the list created at step d).

### CROSS-REFERENCE TO RELATED APPLICATIONS

This Application is a Section 371 National Stage Application of International Application No. PCT/EP2006/009103, filed Sep. 19, 2006 and published as WO 2007/033814 on Mar. 29, 2007, not in English.

### FIELD OF THE DISCLOSURE

The present disclosure concerns a method and a system of access, through a communications network, to information relating to a plurality of users and stored in a storage module.

### BACKGROUND OF THE DISCLOSURE

A telecommunications network such as the Internet places a set of sites at the disposal of the users at which composite multimedia documents, linked to one another by hypertext links, often called web pages are accessible. These sites and the web pages are usually referenced by means of URL resource identifiers (Uniform Resource Locators well known to those skilled in the art) and may be searched for, consulted and viewed by means of software programs called browsers specially designed for this purpose.

Various hardware means may be implemented by a user to access information present within one or more telecommunications networks such as the Internet or more restricted networks such as Intranet type local area networks for companies. Thus, for example, the user may use a terminal to access a server capable of sending him data representing information that he has requested, the user terminal being capable for its part of receiving and storing said data and of processing said data generally by software means. Such a terminal therefore enables a user to access information that he requires from a server of the telecommunications network.

It has been observed that the users of such telecommunications networks are increasingly seeking to communicate with one another in order to exchange information on subjects of common interest. This point is explained especially by J. Donath and N. Robertson of the MIT Media Lab in “The Sociable Web” in Proceedings of the Second International WWW Conference, October 1994. The authors of this article have developed and perfected a method and a system of access to data implementing a server and a terminal for each user. Through his terminal, a user accesses the server and can thus obtain the electronic addresses of other users who, for their part, also have to access the same server. Using the electronic addresses thus obtained earlier, he can also set up communications with other users of his choice so as to exchange information with them, especially by means of instantaneous messaging means or means of access to common discussion pages (known as chat pages) enabling questions and response to be formulated almost instantaneously.

Such a method and system of access nevertheless has a drawback due to the possibility there being large numbers of users who have already accessed said server when the user accesses it. This makes it difficult for the user to choose a third-party user who might potentially be of interest to him for subsequent communications. Furthermore, despite the fact that a central theme of the information consulted by all the users who accessed a same page of the server is the same, third-party users capable of potentially interesting the accessing user are generally not necessarily themselves interested in contact with the accessing user for example because they do not share interest in the same information or through lack of competence in a field to which the information being sought nevertheless belongs.

There are other technical means enabling users to retrieve the contact information of interlocutors with whom they wish to communicate. Such means consist for example of address books or LDAP (Lightweight Directory Access Protocol) type directories well known to those skilled in the art. However, these address books or directories do nothing more than offer consultation of sets of contact information of users who have identified themselves, each set of contact information being accompanied by a profile defined by the corresponding user who, for example, states his centers of interest deemed to be representative of his own personality, etc. Now, such a definition of a profile by the very person to whom this profile is supposed to correspond makes this definition subjective. Furthermore, this definition which uses only a restricted list of points of interest is necessarily simplistic because of the limited choice that it implies. It can therefore be seen that a profile generated according to the above-described method may very often not represent true centers of interest of the person who has defined them and may even, in certain cases, be pure fabrications designed to deliberately deceive users who might place blind trust in this profile.

The users of telephone services also form a population of which many members also try to create groups each defined by a community of centers of interest. Now, as it happens, the nature of the technical means used to provide this population with these telephone services does not make it easy to make information available on the members of this population. It is generally difficult, from outside a telephone network, to access any piece of data on the operation of said network, especially in the case of a switched telephony network (STN).

The above explanation results in an observation: there are many prejudices and difficulties that hinder services for assistance in the creation of users of communications networks where these groups are defined by a community of subjects of interest.

### SUMMARY

An embodiment of the invention proposes a method of access, through a communications network, of information on a plurality of users stored in a storage module, said method being used to provide each user who wishes it with knowledge of other users whose profile shows characteristics sought by this user.

To this end, an embodiment of the present invention provides a method of access, through a communications network, to information on at least one user, especially an identifier enabling this user to be subsequently contacted, and stored in a storage module, said method comprising at least:

a step of transmission, through said communications network, of elements characterizing a user of at least one probe terminal and determined from traces of communications of said probe terminal with at least one server of said network,

a step for the determining, from said transmitted characterizing elements, of at least one profile characteristic proper to said user,

a step of storage of said at least one determined profile characteristic in said storage module,

a step of creation of a list of users comprising, associated with each of said users, at least one identifier for which said at least one profile characteristic stored in the storage step corresponds to at least one profile characteristic defined in a request transmitted by a terminal of a requesting user.

The access method of an embodiment of the invention thus makes it possible, through an associative storage of identifiers of users and profile characteristics pertaining thereto, to constitute a storage module that may contain a profile as representative as possible of the centers of interest of a given user. Such a profile is objective in that it is prepared on the basis of factual elements consisting of a record of one or more signs of interest shown in one or more subjects, these signs being effectively constituted by the very content of the information transmitted by the given user. Any user can thus implement the method of an embodiment of the invention to elaborate his own profile as precisely and objectively as possible, where profiles of third-party users can also be generated objectively by means of the method of an embodiment of the invention so as to make it possible, by true matching of profiles, to obtain the relevant setting up of a contact link between users having a community of subjects of interest.

According to an embodiment of the invention, the items of information transmitted by the first user are analyzed in order to define elements characterizing a content of said information, such as key words or resource identifiers associated with this information, said characterizing information being used to constitute profile characteristics proper to said first user.

The creation step provides a user who asks for it with a list of user identifiers that is as exhaustive as possible depending on the characteristics of their profile sought by this user. Preferably, the users of the list are selected on the basis of a characteristic in common with the user to whom the list relates.

The step of creation of said list may be followed by a step of transmission of said list.

More generally, an embodiment of the invention can furthermore be implemented to create an objective profile of a user in minimizing or even eliminating the risks of incorrect declaration. In such a mode of implementation, the step of creation of a list of users as planned further above is optional, the objective profile obtained being in this case the essential result of a particular implementation of the invention. Indeed, on condition of authorization by the user concerned, this profile could then be transmitted to interested persons or organizations, for example advertisers, who could then select information or generate messages that match the personality and the centers of interest of the user considered.

An embodiment of the invention also relates to a method for processing information pertaining to at least one first user of a terminal, said method comprising at least:

a step of transmission, through a communications network, of elements characterizing said first user and determined from traces of communications of said terminal with at least one server included in said communications network,

a step for the determining, from said transmitted characterizing elements, of at least one profile characteristic proper to said first user, and

a step of storage of said at least one determined profile characteristic in a storage module.

In one embodiment, prior to said steps, the method as described here above comprises a step for the entry, into said storage module, of information relative to at least said second user. This entry step enables said second user for example to use a service for dating other users.

An embodiment of the invention also relates to a system for the processing of information pertaining to at least one first user of a terminal, said system comprising at least:

first means of transmission, through a communications network, of elements characterizing said first user and determined from traces of communications of said terminal with at least one server included in said communications network,

means for the determining, from said transmitted characterizing elements, of at least one profile characteristic proper to said first user, and

means of storage of said at least one determined profile characteristic in a storage module.

According to these modes of implementation of an embodiment of the invention, the profile characteristics could be determined without any possibility for the user of influencing them, so that the profile characteristics thus determined will in principle totally match the real characteristics of said user.

However, the user concerned could have centers of interests in which he will not show signs of interest as yet when his profile is generated. It could therefore be advantageous to give the user a possibility of declaring certain profile characteristics himself, and then combine such declared characteristics with the characteristics obtained automatically through an embodiment of the invention.

In preferred embodiments of the method of the invention, either of the following arrangements is resorted to:

the step for creating the list comprises a sub-step for questioning said storage module by means of said at least one profile characteristic defined in said request, and then a sub-step for making a search, in the storage module, for user profiles at least one of which comprises this characteristic,

the method comprises, prior to said steps described here above, a step for the entry, into said storage module, of information on at least one user liable to communicate with said terminal of said second user when at least one profile characteristic is common to them,

between the steps of storage and creation, there is a step of transmission, at the initiative of said second user, of at least one profile characteristic defined by this user, through the communications network,

the step of transmission is done transparently for said second user.

An embodiment of the invention thus enables a user to set up an address book containing identifiers of users chosen according to the characteristics that he has himself defined. This address book can be fed whenever the user requests it. The address book can also be set up without any intervention by the user, the identifiers being inserted therein automatically and regularly.

An embodiment of the invention also relates to a system of access, through a communications network, to information pertaining to at least one first user, especially an identifier enabling this user to be subsequently contacted, and stored in a storage module, said system comprising:

first means of transmission, through said communications network, of elements characterizing said first user of at least one probe terminal and determined from traces of communications of said at least one probe terminal with at least one server of said network,

means for the determining, from said transmitted characterizing elements, of at least one profile characteristic proper to said first user of said probe terminal,

means of storage of said at least one determined profile characteristic in said storage module,

means of creation of a list of users comprising, associated with each of said users, at least one identifier for which said at least one stored profile characteristic corresponds to at least one profile characteristic defined in a request transmitted by a terminal of a second user.

second means of transmission, through said communications network, to said terminal of said second user of said list of users.

In preferred embodiments of the system of the invention, recourse is had to one or the other of the following devices:

the list creating means comprise means of questioning said storage module by means of said at least one profile characteristic defined by said second user, as well as means for searching, in said storage module, for the user profiles at least one of which comprises this characteristic,

third means of transmission for the transmission, at the initiative of said second user, of at least one profile characteristic defined by this user, through the communications network.

An embodiment of the present invention also relates to an information-processing unit comprising a storage module designed to store information on a plurality of users and transmitted by these users to a communications network, said unit comprising:

means for the determining, from elements characterizing a first user of a probe terminal transmitted through said communications network by said probe terminal, of at least one profile characteristic defined in a request formulated by a second user,

means of storage of said at least one determined profile characteristic,

means of creation of a list comprising at least one identifier associated with a user of a probe terminal when said at least one stored profile characteristic corresponds to at least one profile characteristic defined in a request formulated by a second user,

second means of transmission to said second user, through said communications network, of said created list.

As the particular characteristics and advantages of the access system and processing unit are the same as those of the method described here above, they shall not be recalled here.

According to a preferred implementation, certain steps of the method of access are determined by computer program instructions.

Consequently, an embodiment of the invention also relates to a computer program designed to be installed in a processing unit, said program comprising instructions to implement steps of the access method referred to here above, during an execution of the program by a computation module of said unit.

This program can use any programming language whatsoever and takes the form of a source code, object code, or intermediate code between a source code and object code, as in a partially compiled form or in any other desirable form.

### BRIEF DESCRIPTION OF THE DRAWINGS

The characteristics mentioned here above as well as others shall appear more clearly from the following description of an example of an embodiment, said description being made with reference to the appended drawings, of which:

FIG. 1a shows a first embodiment of an access system in which the method of the invention is implemented;

FIG. 1b shows a second embodiment of an access system in which the method of the invention is implemented;

FIG. 2 shows a processing server implemented in the embodiments of the access system represented by FIGS. 1a and 1b;

FIG. 3 is a flowchart representing different steps executed during the access method according to an embodiment of the invention.

### DETAILED DESCRIPTION OF ILLUSTRATIVE EMBODIMENTS

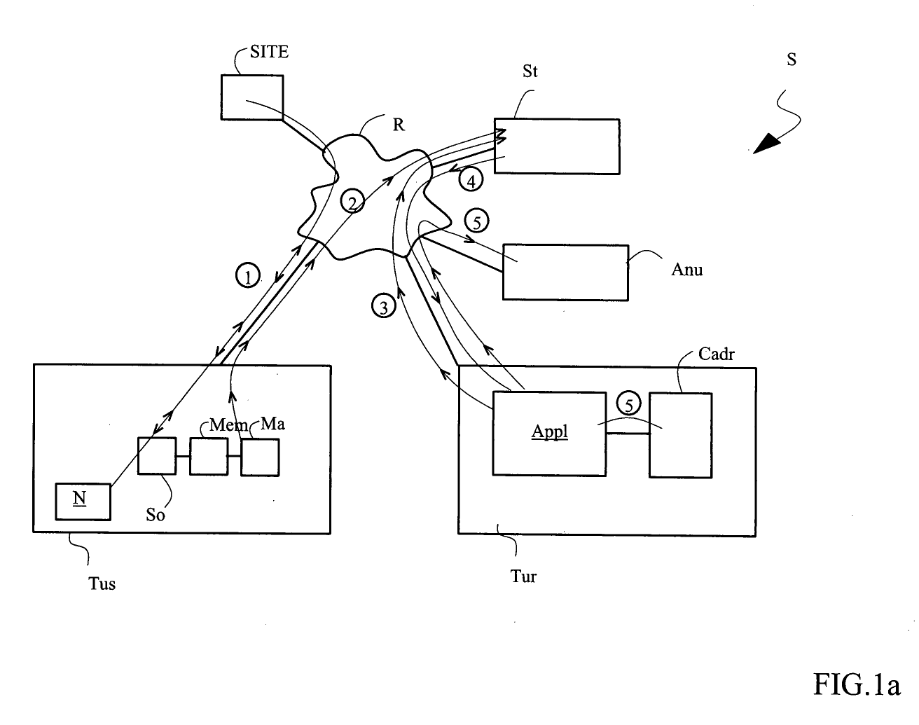

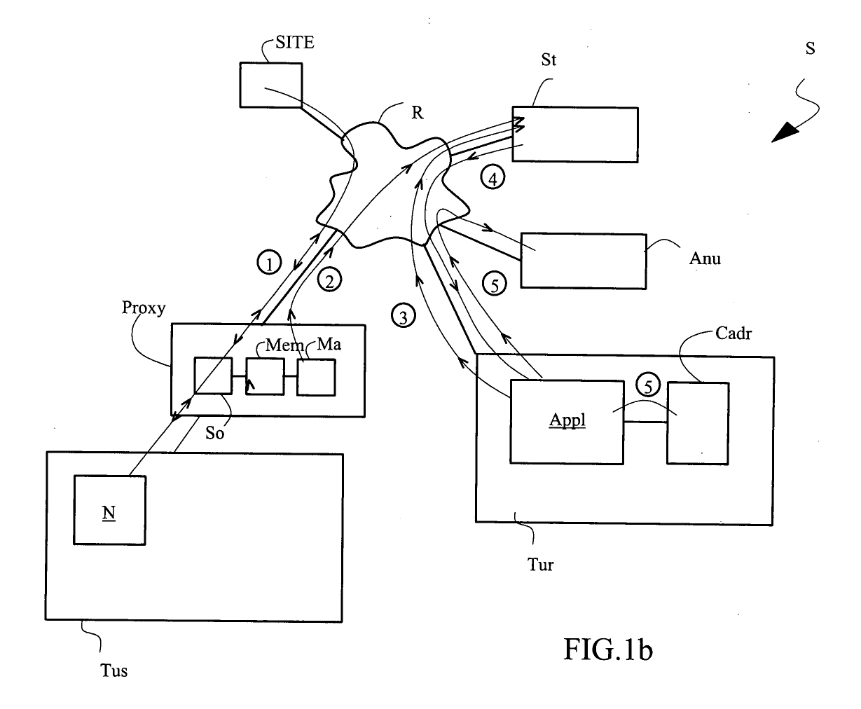

The access system S shown in FIG. 1a comprises a telecommunications network R to which the following are connected respectively: a terminal Tus which, for reasons that shall appear further below, is called a probe terminal, a terminal Tur of a requesting user, at least one server SITE, a processing server St whose function shall be explained here below and a directory Anu.

The telecommunications network R is for example an Intranet network or an Intranet type company local area network or again a network formed by a plurality of interconnected networks such as the Internet with its distributed information system known to those skilled in the art as the World Wide Web. This telecommunications network R enables a user of a terminal, such as the probe terminal Tus, to communicate either with a server SITE or St connected to the network R or with other users. To this end, the probe terminal Tus is provided with a browser N capable of accessing at least one server SITE or St through said telecommunications network R.

In the embodiment shown in FIG. 1a, the access system S also comprises, included in the probe terminal Tus, means such as a probe So for the acquisition of traces of communication between the probe terminal Tus and at least one server SITE which said user of the terminal Tus accesses. These traces contain among others for example for communications between the browser N and a server SITE connected to the communications network R (as is the case in FIG. 1a, see arrow 1), URL resource identifiers specified in one or more requests for access to said server, a period of time spent by the user in consulting a web page of said server SITE identified by a given resource identifier URL or key words representing the content of a web page consulted on said server SITE.

This probe So is furthermore associated with a memory Mem designed to store the traces of communications picked up by the probe So.

The system S also has an analysis module Ma designed to analyze the traces of communications that are stored in the memory Me so as to determine the URL resource identifiers requested during the previous communications as well as the key words associated with the pages then consulted. These URL resource identifiers and these key words form what shall here below be called characterizing elements of the user of a probe terminal.

In a second embodiment shown in FIG. 1b, the probe So, the memory Me, and the analysis module Ma are included in an intermediate server such as a server generally called a “cache” or “proxy” placed between the probe terminal Tus and the network R. It will be noted that a “cache” server is usually provided in order to take reception of HTTP requests from terminals associated with it and to retransmit these requests to the servers that are targeted in these requests and which, in return, will transmit the desired information to them. It is these requests or the information in response to these requests that are picked up by the probe So of the intermediate server P which are then stored in the memory Mem and then analyzed by the analysis module Ma (see arrow 1).

Both in the embodiment of FIG. 1a and that of FIG. 1b, the access system S also comprises a processing server St connected to the communications network R. This processing server St is designed to receive (arrow 2) characterizing elements ELC for at least one user of a probe terminal such as the terminal Tus to be defined by means of these characterizing elements ECL of the user profiles, to receive (arrow 3) requests for user lists REQ from a requesting terminal such as the terminal Tur and to deliver (arrow 4) the requested list of users LURQ to this requesting terminal Tur. In this list of users, there appear the identifiers of said users, thus enabling the requesting user to contact them thereafter if he so wishes.

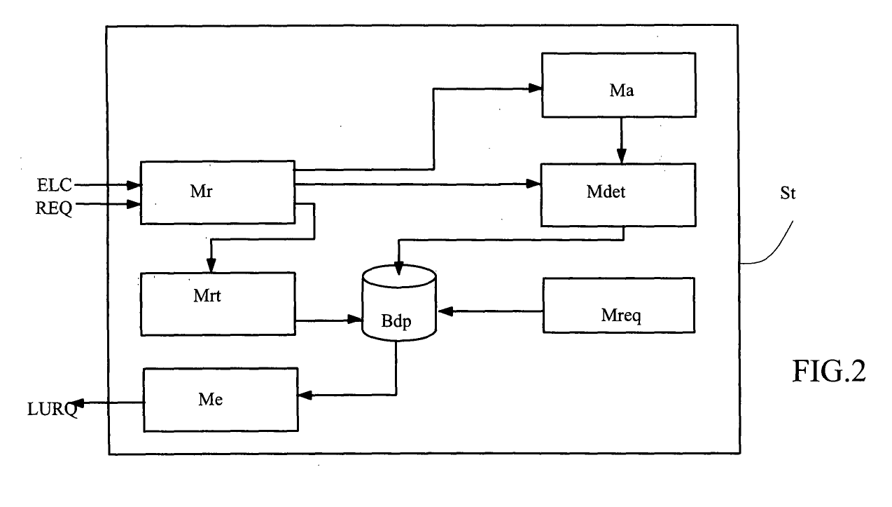

As shown in FIG. 2, the server St comprises a reception module MR designed, as shall be seen here below, to receive either characterizing elements ELC delivered by an analysis module Ma linked to a user or communications traces delivered by a probe So linked to a user or again to receive requests REQ for lists of users, a sending module Me designed to send a requested list of users LURQ to a requesting terminal, a determining terminal Mdet designed to determine profile characteristics from the above-mentioned characterizing elements and a specific storage module here below called a profile database Bdp designed firstly for the storage, in user profiles, of profile characteristics respectively related to these user profiles and secondly for the delivery of the user profiles as a function of requested profile characteristics. The server St furthermore comprises a search and sorting module Mrt linked to the reception module Mr for the reception therein of the requests REQ for user lists and designed to search in the profile database Bdp for profiles of the user profiles corresponding, identically or by resemblance, to the user profile mentioned in said request REQ for user lists and to sort out the profiles obtained in response so as to set up a list of users that is delivered to the sending module Me.

The probe So, the analysis module Ma and the determining module Mdet form means of determining characteristics.

The user profile of each user takes the form, in the database Bdp, of a memory space specifically assigned to the user concerned.

The use of such a database Bdp to store the profile characteristic or characteristics of a user has the advantage of permitting easy and non-redundant updating. In particular, the memory space assigned to each user profile, which may already comprise characteristics obtained in a previous access, can easily receive complementary profile characteristics used to refine the profile concerned and further increase its relevance.

In one variant (not shown) of the access system S of an embodiment of the invention, the network R is a telephone network such as the switched telephone network STN or a telephone network working with the IP (Internet protocol). For each communication, the probe So then picks up for example the telephone numbers of the caller and the called party and the starting time of the call and its duration. The characterizing elements which are determined by the means of analysis Ma are for example the telephone numbers of the caller and the called party, the type of telephone used (fixed, mobile, Internet, etc.), the call connection time as well as the frequency of calls by a user relative to all the calls connections with this same user.

A requesting terminal such as the terminal Tur comprises an application Appl. This application Appl is designed to send the processing server St a request REQ of a list of users who have a profile specified by at least one profile characteristic contained in said request (arrow 3). This application Appl is also designed to receive (arrow 4) the list of users LURQ corresponding to said request. This application Appl is also designed to store (arrow 5) said elements of said list in an address book Cadr that is contained in said requesting terminal Tur and is then no longer accessible except by the requesting terminal Tur alone and/or in a directory Anu which is connected to the network R and is then accessible by any requesting terminal of the network R.

It will be understood that the application Appl can be installed in a server included in the network R and that it can be launched by a requesting terminal after this terminal has accessed said server or that it can even be shared between a requesting terminal and a server such as this of the network R.

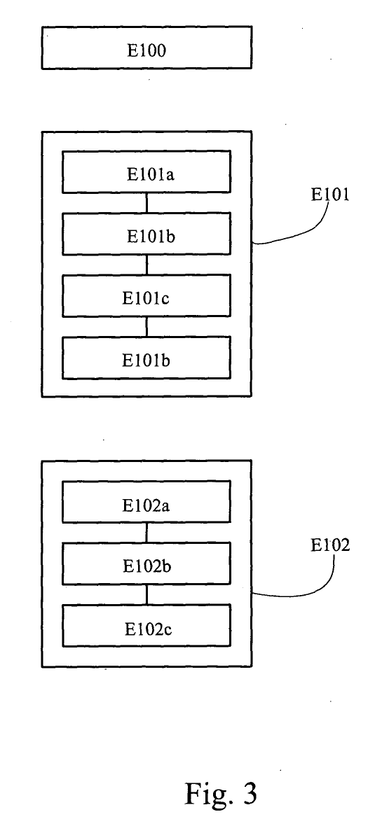

The working of the system S shall be explained by the description of the method of an embodiment of the invention that it implements. It shall be explained with reference to FIG. 3. During a step E100 prior to the implementation of the method itself, the user who wishes to be able to contact other users and therefore obtain their user identifiers registers himself or gets registered by an approved organization on the server St in giving it information, especially through a user identifier, an electronic address or a telephone number or possibly through other items of information such as one or more centers of interest, a geographical location, a professional title, an age, etc. This information is registered in a profile which is assigned to this user in the profile database Bdp of the server St.

The method of an embodiment of the present invention comprises a determining step E101 implemented by a probe terminal Tus and a processing server St and an issuing step E102 for issuing lists of users that is carried out by a requesting terminal Tur and the processing server St. These two steps can be implemented independently of each other. Although an embodiment of the present invention has been described in considering a probe terminal and a requesting terminal, it will be understood that in general a given terminal is both a probe terminal and a requesting terminal and that it therefore possesses the means of both types of terminals at the same time.

The determining step E101 comprises an acquisition sub-step E101a during which the traces of communications calls are picked up by the probe So and stored in the memory Mem designed for this purpose as well as an analysis sub-step E101b during which the analysis module Ma of the probe So determines characterizing elements from information contained in said picked-up communications traces. The characterizing elements are transmitted from the probe terminal Tus to the processing server St (see arrow 2 of FIGS. 1a and 1b). The characterizing elements determined by the analysis module Ma of the probe So are transmitted regularly to the processing server St, for example once a day.

These different sub-steps are implemented by a probe terminal Tus. The method of an embodiment of the present invention furthermore comprises a determining sub-step E101c during which the determining module Mdet of the processing server St determines at least one profile characteristic from the characterizing elements determined in the previous sub-step. The profile characteristics as determined at the sub-step E101c are for example affinity for DIY activities, finance or a preferred mode of communication, a preferred interlocuter, etc. During a storage step E101d, the profile characteristics determined by the determining module Mdet are included in the corresponding user profile which is stored in the database of profiles Bdp.

It will be noted that in this way the database Bdp is supplied with profile characteristics proper to each user and that this is done regularly. Profile characteristics of a user of a probe terminal Tus are determined from communications traces picked up during each of these communications calls, for example with the server, such as the server SITE of FIGS. 1a or 1b, connected to the network R.

The method of an embodiment of the present invention also comprises a step for the creation of lists of users E102 itself comprising a sub-step E102a for the formulation of a request REQ comprising at least one profile characteristic and for the transmission of said request REQ to the processing server St and more particularly to the search and sorting module Mrt of the server St. This sub-step 102a is implemented by a requesting terminal Tur.

The method of an embodiment of the invention furthermore comprises a sub-step E102b for searching for this characteristic in the profile database Bdp which sends back a list LURQ of the user identifiers whose profile comprises this characteristic or at least one similar characteristic. The list LURQ set up by the processing server St is then transmitted in the sub-step E102c to the application Appl included in said terminal Tur of the requesting user. This sub-step E102c is implemented by the processing server St.

The step E102a for formulating the request may be implemented according to the following variants.

In a first variant, the user requesting the terminal Tur uses a man-machine interface and the specific application Appl to enter at least one profile characteristic comprising for example a word, for example “Paris”, “bicycle”, etc. or else a sentence in natural language such as “I'm looking for people with a similar profile to mine”. The application Appl then composes said request which comprises the entered characteristic or characteristics.

According to a second variant, at least one profile characteristic is defined once and for all by the user of the terminal Tur and stored in a specific memory made available to the application Appl. This application formulates a request REQ, including this profile characteristic or these profile characteristics therein.

Once the request REQ has been formulated (step E102a), it is transmitted to the processing server St (see arrow 3 of FIGS. 1a and 1b). The processing server St takes reception of this request REQ by means of its reception module Mr and forwards it in turn to the search and sorting module Mrt. This search and sorting module Mrt then makes a search in the profile database Bdp and create a list of user identifiers whose profile comprises the characteristics of the request or at least similar characteristics (step E102b). This list of identifiers can then be ordered so as to highlight the identifiers for which the characteristics sought are the most important and the most relevant. Preferably, the characteristic or characteristics sought belong to the profile of the user of the requesting terminal.

The list of users thus created contains user identifiers and all or part of the profile of the corresponding user. For example, for each user selected, the list may contain his user identifier or his contact information, his preferred sport and his telephone number or his access address (e-mail address, Internet address etc).

This list is then transmitted (step E102c) by the sending module Me of the processing server St to the application Appl which displays it on the screen of the requesting terminal Tur. The user of the requesting terminal Tur can then store all or part of the list displayed in the address book Cadr associated with the application Appl. It will be noted that, the depending on the capacities of the address book, not all the displayed characteristics can necessarily be stored. Thus, an address book of this kind could, for example, store only the identifiers of the users displayed and their telephone numbers or their access addresses.

The list of users can also be transmitted either directly by the processing server St or indirectly by the application Appl (as is shown in FIGS. 1a and 1b by the arrow 5), to a directory Anu included in the network R.

If some of the identifiers of the list are already known to the address book or the directory, they are not re-registered but an updating of the profile of the corresponding users is nevertheless done.

According to another variant, the processing server St comprises a request set-up module Mreq. Thus, the request comes from the processing server St itself, transparently for every user of requesting terminal. A certain number of requests is stored preliminarily in the request set-up module (Mreq) of the processing server St associated with the requesting terminal. These requests are formulated on the basis of at least one profile characteristic defined by the user of said requesting terminal Tur. With each request, there are associated pieces of information pertaining to said user, the frequency of launching of the request, the application Appl designed to receive the corresponding list obtained, etc.

Recurrently, the request set-up module Mreq launches a request in questioning the profile database Bdp by means of at least one predefined profile characteristic. In a manner similar to the variants described here above, the search and sorting module Mrt creates a list of user identifiers corresponding to this request which is transmitted to the application Appl and stored in relation with the request.

It will be noted that an embodiment of the invention can preferably be applied in the particular context of life in a firm, especially because of the restricted number of potential users of the system and the ease with which they can be identified.

Although the present disclosure has been described with reference to one or more examples, workers skilled in the art will recognize that changes may be made in form and detail without departing from the scope of the disclosure and/or the appended claims.

1. Method for the processing of information pertaining to at least one first user of a terminal, said method comprising at least:
a step of transmission, through a communications network, of elements characterizing said first user and determined from traces of communications of said terminal with at least one server included said communications network,
a step of determining, from said transmitted characterizing elements, of at least one profile characteristic proper to said user, and
a step of storage of said at least one determined profile characteristic in a storage module.

2. Method according to claim 1, wherein the method furthermore comprises a step of creation of a list of users comprising, associated with said users, at least one identifier for which said at least one profile characteristic stored in the storage step corresponds to at least one profile characteristic defined in a request transmitted by a terminal of a requesting, second user.

3. Method according to claim 2, according to which the list-creation step comprises a sub-step of questioning said storage module by said at least one profile characteristic defined in said request, and then a sub-step for making a search, in the storage module, for user profiles at least one of which includes this characteristic.

4. Method according to claim 2 comprising, prior to said steps, a step of entry, into said storage module, of information on at least one user liable to communicate with said terminal of said second user when at least one profile characteristic is common to said at least one user and said second user.

5. System for the processing of information pertaining to at least one first user of a terminal, said system comprising at least:
first means of transmission, through a communications network, of elements characterizing said first user and determined from traces of communications of said terminal with at least one server included in said communications network,
means for the determining, from said transmitted characterizing elements, of at least one profile characteristic proper to said first user, and
means of storage of said at least one determined profile characteristic in a storage module.

6. System according to claim 5, wherein the method furthermore comprises means of creation of a list of users comprising, associated with each of said users, at least one identifier for which said at least one stored profile characteristic corresponds to at least one profile characteristic defined in a request transmitted by a terminal of a second user.

7. System according to claim 6 wherein said list-creation means comprise means of questioning said storage module by means of said at least one profile characteristic defined in said request, as well as means for searching, in said storage module, for user profiles at least one of which comprises this characteristic.

8. System according to claim 6, furthermore comprising means of transmitting, at the initiative of said second user, of at least one profile characteristic defined by the second user, through the communications network.

9. Information-processing unit comprising a storage module designed to store information pertaining to a plurality of users and transmitted by these users to a communications network, said unit comprising:
means for the determining, from elements characterizing a first user of a probe terminal transmitted through said communications network by said probe terminal, of at least one profile characteristic proper to said first user,
means of storage of said at least one determined profile characteristic,
means of creation of a list comprising at least one identifier associated with a user of a probe terminal when said at least one stored profile characteristic corresponds to at least one profile characteristic defined in a request formulated by a second user,
second means of transmission to said second user, through said communications network, of said created list.

10. A method according to claim 1, comprising, prior to said steps, a step for the entry, into said storage module, of information relative to at least a second user.

11. Computer program stored in a storage module and designed to be installed in a processing unit, said program comprising instructions to implement steps of a method for processing of information pertaining to at least one first user of a terminal, during an execution of the program by a computation module of said unit, said method comprising at least:
a step of transmission, through a communications network, of elements characterizing said first user and determined from traces of communications of the terminal with at least one server included said communications network,
a step of determining, from said transmitted characterizing elements, of at least one profile characteristic proper to said user, and
a step of storage of said at least one determined profile characteristic in a storage module.
